(19) United States
(12) Patent Application Publication
(10) Pub. No.: US 2012/0318618 A1
(43) Pub. Date: Dec. 20, 2012

(54) ELEVATOR HAVING A COUNTERWEIGHT

(75) Inventor: Jose Ruiz, Sao Paulo (BR)

(73) Assignee: INVENTIO AG, Hergiswil NW (CH)

(21) Appl. No.: 13/518,142

(22) PCT Filed: Dec. 1, 2010
(86) PCT No.: PCT/EP2010/068586

§ 371 Date: Aug. 30, 2012

(30) Foreign Application Priority Data
Dec. 21, 2009 (EP) 09180113.4

(51) Int. Cl. B66B 7/02; B66B 7/04

(52) U.S. Cl. 187/406

(57) ABSTRACT

An elevator has at least one elevator body which can be displaced along a track and has at least one guide element, which is guided by a plurality of counter-pieces of the guide element connected in a stationary manner to the track and lying atop one another in a vertical manner. The guide element is always engaged by at least two of the counter-pieces.

### FIELD

The invention relates to an elevator having a counterweight.

### BACKGROUND

An elevator usually has an elevator car for accommodating people or goods, the car being connected to a counterweight by means of a supporting and pulling means. The supporting and pulling means here runs over a driving pulley, which is driven by a drive. The driving pulley divides the supporting and pulling means into a first and second supporting- and pulling-means strand. The elevator car here is suspended on the first supporting- and pulling-means strand and the counterweight is suspended on the second. The counterweight serves, on the one hand, for compensating for the weight of the car and, on the other hand, for ensuring traction between the supporting and pulling means and the driving pulley. It is ensured here that the traction is sufficient in order to displace the elevator car, and accordingly also the counterweight along a track.

EP 1 415 948 A1 discloses an elevator car and a counterweight each suspended on a supporting and pulling means with a 1:1 suspension ratio. The elevator car and the counterweight have guide shoes and are each displaced thereby along two guide rails. The length of these guide rails extends essentially over the entire track length of the counterweight. This method of elevator-car and counterweight guidance is extremely reliable and is widely used in elevator construction. However, it has the disadvantage that, in relative terms, a large quantity of steel is required in order to produce the guide rails. With resources becoming increasingly scarce, and raw materials increasing in cost as a result, this can result in the cost of an elevator increasing considerably.

### SUMMARY

It is therefore the object of this invention to produce an elevator having an elevator car and/or a counterweight, in particular the guide means thereof, in such a manner as to cut back on materials as much as possible.

An elevator thus has, for example, at least one elevator body, which can be displaced along a track. The elevator body itself has at least one guide element, which is guided by a plurality of counterparts to the guide element, these being located vertically one above the other and being connected to the track at a fixed location. The guide element here is always in engagement with at least two counterparts.

An “elevator body” is understood as meaning an elevator car, a counterweight or the like.

The advantage of the invention is that the guide element extends essentially only over the length of the elevator body. This makes it possible, in comparison with conventional guide elements such as guide rails, which typically extend along the entire track of the elevator body, to cut back on materials to a considerable extent.

The track of the elevator is bounded, in a building, predominantly by an elevator shaft, which typically comprises four side walls, a shaft ceiling and a shaft floor. Furthermore, the track may also be bounded by a framework or latticework structure. Such structures can be installed, for example, retrospectively in a staircase or stairwell of a building or installed on the outside of a building.

The counterparts are aligned vertically one above the other along at least one straight line and predetermine the movement direction of the guide element and/or of the elevator body. This makes it possible to achieve satisfactory guidance of the elevator body.

In a further embodiment of the elevator, a distance between two adjacent counterparts, as seen in the direction of travel of the counterweight, is smaller than half the length of the guide element. This ensures that the guide element, at any one time, is in engagement with at least two counterparts and is guided reliably in the process.

In a further embodiment of the elevator, the elevator body has two guide elements, each located on opposite sides of the elevator body. Each of these two guide elements is guided by a plurality of counterparts which are located vertically one above the other. The counterparts are arranged in pairs at the same level. This has the advantage that the guide forces which act between the counterparts and the guide elements are introduced symmetrically into a structure which bounds the track.

In a further embodiment of the elevator, a guide surface of the counterparts and/or of the guide elements is provided with a sliding layer.

The sliding layer has the advantage that the friction between a counterpart and a guide element is reduced. This means that less drive energy is required and these elevator components are subject to less wear. This results in the elevator being a better prospect both from an economic and from an ecological point of view.

In a further embodiment of the elevator, the guide element is designed as a rail and a counterpart is designed as a guide shoe. Guide shoes and guide rails are guide elements which are widely used in elevator construction. This has the advantage that use can be made of favorable and tried-and-tested standard elements.

In an alternative embodiment, the guide shoes comprise a guide surface with at least one roller. Since the rolling friction is less than the sliding friction, this roller likewise results in a reduction in the friction between a guide shoe and a guide rail. Such a roller may be arranged preferably on a side of the guide shoe which is opposite the end surface of the guide rail. Furthermore, as an alternative, or in addition, it is also possible to arrange further rollers on at least one side of the guide shoe which is opposite the lateral surfaces of the guide rail. In a particularly preferred embodiment, the guide shoe comprises at least two, four or six rollers, each offset one behind the other as seen in the direction of travel, in order to avoid rotation of the guide rail about a roller axis.

In a further embodiment of the elevator, the guide shoes have two introduction regions, into which a guide rail can be introduced. The guide shoes, in addition, have a guide region, which is aligned between the two introduction regions. The guide region guides the guide rail once introduced into the guide shoe. A tolerance of fit here between the guide rail and the introduction regions is greater than a tolerance of fit between the guide rail and the guide region.

The tolerance of fit between the guide rail and an introduction region is selected such that the guide rails can be introduced reliably into the guide shoes, even if vibration of the elevator body and/or of a guide rail occurs during operation. In particular, it is ensured that a guide rail comes into contact with the opening of a guide shoe.

### DESCRIPTION OF THE DRAWINGS

The invention will be clarified, and described further in detail, hereinbelow by way of exemplary embodiments and drawings, in which:

FIG. 1 shows an elevator having a drive and an elevator car and a counterweight, which can be displaced along a track;

FIG. 2 shows a plan view of a first embodiment of a counterweight, having two guide rails and two guide shoes;

FIG. 3 shows a side view of the first embodiment of the counterweight;

FIG. 4 shows a plan view of a second embodiment of a counterweight, having a single guide rail and a single guide shoe; and

FIG. 5 shows a guide shoe with an introduction region.

### DETAILED DESCRIPTION

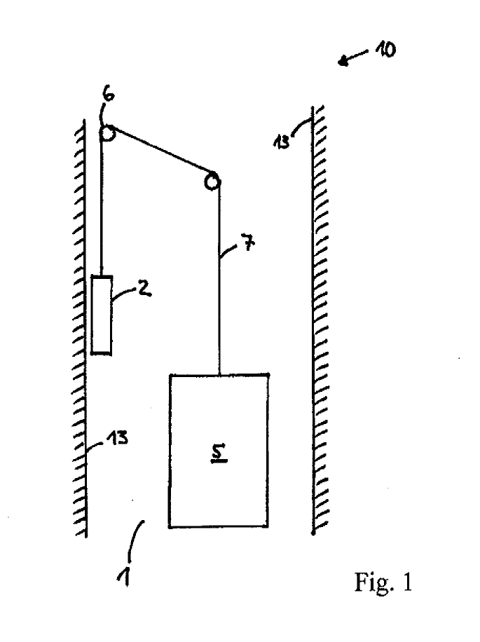

FIG. 1 shows an elevator 10, which has an elevator car 5 and a counterweight 2. The elevator car 5 and the counterweight here are connected to one another via a supporting and pulling means 7, In the example shown, both the elevator car 5 and counterweight 2 are suspended with a suspension ratio of 1:1. As is known, it is likewise possible for the elevator car 5 and/or the counterweight 2 to be suspended as a bottle with a suspension ratio of 2:1 or higher. The supporting and pulling means 7 is typically designed as a cable or belt comprising, for example, tension members made of aramid or steel. The supporting and pulling means 7 are in operative contact with a driving pulley 6 which, for its part, is connected to a drive. The drive generates a drive torque, which acts on the supporting and pulling means 7 via the driving pulley 6, This drive thus allows the elevator car 5 and the counterweight 2 to be displaced vertically along a track 1. The track 1 is bounded, for example, by an elevator shaft.

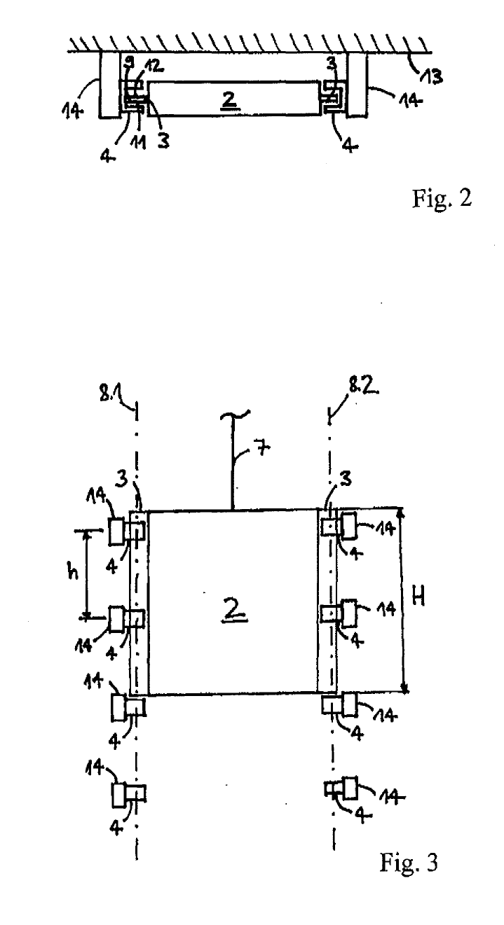

FIGS. 2 and 3 illustrate a first exemplary embodiment of the elevator 10. FIG. 2 here shows a plan view of an elevator body designed as a counterweight 2. The counterweight 2 has two guide elements, which are located on opposite sides of the counterweight 2 and are designed as guide rails 3.

It is preferable for the two guide rails 3 to be fixed, for example by screw connections, each on one side of the counterweight 2.

It is also possible, in an analogous manner, to realize an elevator body designed as an elevator car. In this case, two guide rails are arranged on the elevator car. The guide rails are preferably connected to a frame of the elevator car.

In a further embodiment, the guide rails 3 and the counterweight 2 or at least parts of the counterweight 2, for example a counterweight frame which can accommodate weights, are formed in one piece. It is possible here for the guide rails 3 and counterweight 2 to be primarily formed by casting. Guide surfaces of the guide rails 3 can undergo follow-up processing, in order for surface qualities which are required for guidance purposes to be formed.

At least two guide shoes 4, which form a pair of guide shoes 4, are provided in order to guide the two guide rails 3. This pair of guide shoes is arranged in a horizontal plane and fastened, for example by means of a support 14 in each case, on a supporting structure, which bounds the track 1. This supporting structure is, for example, a side wall 13 of an elevator shaft. A guide shoe 4 preferably has, essentially as shown in FIG. 2, a U-shaped profile, which defines three guide surfaces for a guide rail 3: a guide surface 9, which guides the end side of the guide rail 3, and two guide surfaces 11 and 12, which guide the lateral sides of the guide rail 3. The two guide shoes 4 of a pair of guide shoes have their open sides oriented toward one another.

FIG. 3 illustrates a detail of a side view of the elevator 10, wherein, at a certain moment in time, the counterweight 2 is in engagement with two upper pairs of guide shoes. Two further pairs of guide shoes are arranged therebeneath. The guide shoes 4 shown on the left here are located on a first vertically oriented straight line 8.1 and the guide shoes 4 shown on the right are located on a second straight line 8.2, which is oriented essentially parallel to the first straight line 8.1. The distance h between two adjacent pairs of guide shoes located one above the other is smaller than half the length H of a guide rail 3, as a result of which at least two pairs of guide shoes always guide the counterweight 2 or the elevator car 5 on its guide rails 3.

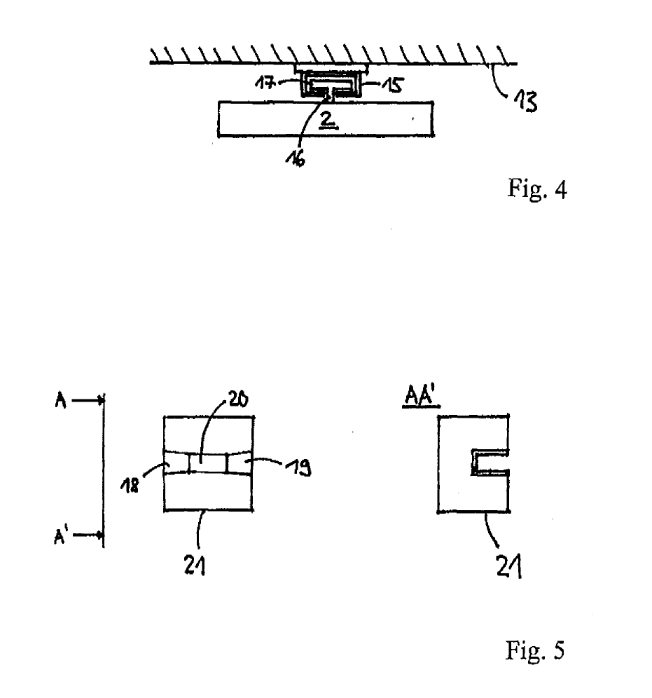

FIG. 4 shows a second exemplary embodiment of the elevator 10. In this exemplary embodiment, the elevator 10 has a counterweight 2 which is guided on a single guide rail 16. Accordingly, the associated guide shoes 15 are arranged vertically along a straight line.

As illustrated in FIG. 4, the guide shoes 15 are fastened on a shaft wall 13. In order to ensure that the counterweight 2 is guided reliably, the guide rail 16, which is fastened on the counterweight 2, not only has its end surface and both lateral surfaces guided by a guide shoe 15, but also additionally has a flange 17 fastened orthogonally on the end surface. This flange 17 defines an undercut surface, which serves as an additional guide surface. Accordingly, a guide rail 15 is formed as an open quadrilateral hollow profile, wherein the opening of the profile forms a preferably central through-passage through a side surface directed toward the counterweight 2, the through-passage extending along the longitudinal axis of the profile. The additional guide surface ensures that the distance between the counterweight 2 and the shaft wall 13 remains essentially constant.

FIG. 5 shows a guide shoe 21 which has two introduction regions 18, 19, into which a guide rail can be introduced. A guide region 20 is located in a central region of the guide shoe 21. This guide region 20 is designed such that a corresponding guide rail is guided in a reliable manner. The guide region 20 is aligned between the two introduction regions 18, 19. These introduction regions 18, 19 open outward, preferably in a funnel-like manner, and therefore a guide rail comes into contact with an introduction region 18, 19 of the guide shoe 21 even if vibration occurs. That is to say that a tolerance of fit between the guide rail and the introduction regions 18, 19 is greater than a tolerance of fit between the guide rail and the guide region 20.

In a further variant, the introduction region of the guide shoe is designed as a roller arrangement. The introduction region here has at least two rollers, each arranged opposite a lateral side of the guide rail. In addition, it is optionally possible to provide a third roller, which is located opposite the end side of the guide rail. In this variant, the tolerance of fit between the guide rail and the roller arrangement of the introduction region corresponds largely to the tolerance of fit between the guide rail and the guide region.

In yet a further variant, the counterpart can also be designed as a guide-roller arrangement. It is customary here to provide a guide roller for each guide surface of a guide element, this guide roller rolling in each case on an associated guide surface of the guide element. In the case of a conventional guide rail, which serves as a guide element, the guide-roller arrangement comprises three guide rollers: a first guide roller guides the end side, a second guide roller guides a first lateral side, and a third guide roller guides a second lateral side of the guide rail.

A guide shoe as described in the manner above having a guide region and two introduction regions can be used both for guiding a counterweight and for guiding an elevator car.

In accordance with the provisions of the patent statutes, the present invention has been described in what is considered to represent its preferred embodiment. However, it should be noted that the invention can be practiced otherwise than as specifically illustrated and described without departing from its spirit or scope.

1-8. (canceled)

9. An elevator having at least one elevator body, which at least one elevator body is displaced along a track, comprising:
at least one guide element on the at least one elevator body; and
a plurality of counterparts being located vertically one above another and being connected to the track at fixed locations, the at least one guide element being guided by the counterparts wherein the at least one guide element is always in engagement with at least two of the counterparts during displacement of the elevator body along the track.

10. The elevator according to claim 9 wherein a distance between two adjacent ones of the counterparts in a direction of travel of the elevator body is smaller than half a length of the at least one guide element.

11. The elevator according to claim 9 wherein the elevator body has two of the at least one guide element, each of the guide elements located on opposite sides of the elevator body and each guided by the counterparts that are located vertically one above the other and are arranged in pairs at the same level along the track.

12. The elevator according to claim 11 wherein a guide surface of the counterparts is provided with a sliding layer.

13. The elevator according to claim 11 wherein a guide surface of the guide elements is provided with a sliding layer.

14. The elevator according to claim 9 wherein the at least one guide element is formed as a guide rail and the counterparts are formed as guide shoes.

15. The elevator according to claim 14 wherein the guide shoes have two introduction regions, into which the guide rail can be introduced, and have a guide region that is aligned between the two introduction regions and guides the guide rail once introduced into the guide shoes, and wherein a tolerance of fit between the guide rail and the introduction regions is greater than a tolerance of fit between the guide rail and the guide region.

16. The elevator according to claim 9 wherein the elevator body is an elevator car or a counterweight.
